(19) United States
(12) Patent Application Publication
(10) Pub. No.: US 2021/0283824 A1
(43) Pub. Date: Sep. 16, 2021

(54) THERMALLY DEFORMABLE PLATE

(71) Applicant: SENOPLAST KLEPSCH & CO. GMBH, Piesendorf (AT)

(72) Inventor: Manfred OBERKOFLER, Uttendorf (AT)

(21) Appl. No.: 16/339,108

(22) PCT Filed: Oct. 13, 2017
(86) PCT No.: PCT/EP2017/076197

§ 371 Date: Apr. 3, 2019

(30) Foreign Application Priority Data
Oct. 14, 2016 (EP) 16194022.6

(51) Int. Cl. B29C 51/26; B29C 51/00; B29C 51/14

(52) U.S. Cl. CPC B29C 51/264; B29K 2101/12; B29C 51/14; B29C 51/002

(57) ABSTRACT

A thermally deformable plate or film, comprising a thermoplastic plastic plate or plastic film (2, 3) and, arranged thereupon, a lacquer cover layer (1) having at least two constituents, characterized in that the lacquer cover layer (1) has a thermoformable component as a first constituent and a thermally curable component as a second constituent.

The invention relates to a thermally deformable plate or film as well as a method for the production of such a plate or film. The invention further relates to a thermally deformed plate as well as various applications of such plates.

### PRIOR ART

Thermally deformable plates are used in numerous fields of application such as, e.g., in the automobile industry for car body elements of vehicles, lorries, caravans, building machineries, utility vehicles, in the sanitary field for bath tubs or shower stalls, in the furniture industry as furniture films, in the building sector, with E&E housings, for recreational and sports devices or in the railway supply and aviation industry. While such plates may be excellently processed, they often do not reach the features required in the respective field of use. In particular the mechanical and physico-chemical features such as scratching resistance, chemical resistance, e.g., for automobile application, are often not sufficient.

In prior art, there have already been described various solutions how to increase the surface features of such thermally deformable plates. In EP 1 737 654 B1, for example, there is described a “dual cure” system, wherein a dual-step curable lacquer is applied onto a web-like material by means of rollers, blades or flooding and is subsequently physically dried by the solvent of the lacquer being expulsed. The plate having such a partially cured lacquer layer is then subjected to a thermoforming process or a thermoplastic deformation, respectively. Upon deformation, the lacquer layer is then cross-linked by way of UV radiation and completed cured. In this prior art there arise two problems: firstly, the partially cured plate is not stackable and not storage-stable. Secondly, the UV curing has proven to be difficult in “shadow regions”, this is regions, which occur due to the 3D geometry of the plate or film and are inaccessible for UV radiation.

Another approach according to prior art pursues the strategy of the subsequent lacquer application onto the plate or film. Thereby, a plastic plate or film is thermoformed and subsequently lacquer-applied, e.g., by means of spray-application of lacquer or flooding. Even though this procedure per se offers good results, it is rather complex and associated with a lot of overspray and subsequent rework. Furthermore, there may occur coating strips in these methods; in the spray-application of lacquer there is often observed an undesired orange peel, or a rainbow effect with flooding. Also in these methods, there are existent problems with the lacquer application onto regions, which are difficult to access due to the geometry of the thermoformed plate.

A third approach according to prior art is the so-called two-component injection moulding. Therein, in a liquid injection moulding machine there is introduced a liquid multi-component reactive system into the cavity of the moulding tool of the injection moulding machine and then the coating is distributed in the following stamping step evenly on the surface of the mould. The coating is cured in the moulding tool such that the element may be deformed. Upon removal of the element, the lacquer is cured by means of UV radiation. This method provides for very scratch-resistant surfaces, it is, however, extremely expensive, applicable only for small-surface elements and is also unsuitable for shadow regions. Application for automobile car bodies is hardly feasible within a reasonable frame of costs.

### SHORT DESCRIPTION OF THE INVENTION

All methods according to prior art thus are either expensive, complex or do not provide a uniform coating with the lacquer layer over the entire surface.

Thus it is the task of the present invention to provide a thermally deformable plate or film, wherein these disadvantages do not occur.

This task is solved by a thermally deformable plate or film, comprising a thermoplastic plastic plate or plastic film and, arranged thereupon, a lacquer cover layer having at least two constituents, characterized in that the lacquer cover layer has a thermally deformable component as a first constituent and a thermally curable component as a second constituent.

Such a plate or film may be provided directly by the manufacturer of the thermoplastic plastic plate or plastic film by applying a lacquer onto the thermoplastic plastic plate or plastic film, which is curable in two steps. The first step of curing is carried out, e.g., at the manufacturer of the thermoplastic plastic plate or plastic film, whereas the second step—the final curing of the lacquer—will take place at the site of the thermoforming process, simultaneously with the thermoforming process.

With the lacquer cover layer there is not to be understood that there are two separate layers with having respectively one of the two constituents. With the lacquer cover layer there is rather to be understood that the two constituents of the lacquer cover layer are mixed or blended, respectively, with one another.

When being applied onto the plastic film or plate, the lacquer is still liquid. Subsequently the first constituent is being cured. The cured first constituent is thermoformable, i.e. upon exposure to temperature and pressure, the first constituent may be reversibly deformed.

Upon curing of the first constituent, the lacquer cover layer is already so hard such that a storage or stacking of the plates or films or the subsequent thermoforming of such a plate or film, respectively, is possible without impairment of the optical nature and the surface quality, in particular of the gloss. The lacquer cover layer, however, has not been completely cured. Upon curing of the first constituent and before the thermal curing of the second constituent, the lacquer cover layer preferably has a chemical resistance to acetone of less than 5 minutes. Upon curing of the second constituent, the lacquer cover layer has a chemical resistance to acetone of more than 5 minutes.

For this reason, there is provided that the first thermoformable constituent is cured such that thermoforming is possible. Initially, when applying the lacquer cover layer, the first constituent or the components of the first constituent, respectively, have still been liquid and have not been cured.

The second constituent of the lacquer cover layer is preferably cured completely when thermoforming the plate or film. Optionally, there may be additionally required a little, preferably thermal, post-curing process. Curing is understood as that process, wherein the polymerization process is initiated by polymerization of the monomers and oligomers in the lacquer cover layer, such that the hardness of the lacquer cover layer is increased.

Thermally deformable plate or film is understood as that the plate or film may be deformed by exposure to pressure and temperature. In this deformation, the second constituent of the lacquer cover layer is cured. The thermally deformable plate or film may also be thermoplastically deformable.

In a further aspect the invention relates to a method for the production of a thermally deformable film or plate.

The method for the production of a thermally deformable plastic plate or plastic film includes the following steps:

(i) providing a thermoplastic plastic plate or plastic film,
(ii) applying a lacquer having a first curable constituent, which is thermoplastically deformable in the cured condition, and a second, thermally curable constituent,
(iii) curing only the first curable constituent.

In one aspect the invention also relates to a method for the production of a deformed plastic plate or plastic film, including either the following steps:

(i) providing a thermoplastic plastic plate or plastic film,
(ii) applying a lacquer having a first curable constituent, which is thermoplastically deformable in the cured condition, and a second, thermally curable constituent,
(iii) curing only the first curable constituent, i.e. without curing the second constituent,
(iv) thermoforming the plastic plate into a desired three-dimensional shape while simultaneously curing the thermally curable component;

or including the following steps:

(a) providing a thermoplastically deformable plate or film of the type mentioned above and
(b) thermoforming the plastic plate into a desired three-dimensional shape while simultaneously curing the thermally curable component.

Fields of application for such plates or films comprise, for example, the automobile industry, railway supply and aviation industry; the furniture industry; building industry; the sanitary field; recreation and sports.

In the automobile industry, in the railway supply and aviation industry, these are used, for example, for the exterior area such as car body elements of vehicles, lorries, caravans, building machineries, utility vehicles such as roof modules, decorative covers, bumpers, car hood covers, full-surface car body parts, or the interior area such as covers, decorative panels, decorative covers, displays, functional operation units etc. In the furniture industry, there are to be mentioned as examples furniture films, furniture parts and the like. In the sanitary field there are to be mentioned, for example, bath tubs and shower stalls. In general, such films may be used as housings in all areas of the industry, for suitcases or housings for devices, etc., or in the building industry, in E&E housings, for recreational and sports utilities. In particular the mechanical and physico-chemical features such as scratch resistance, chemical resistance, e.g., for application in automobiles are often not sufficient in prior art, such that there is existent a great demand for films or plates according to the invention.

### DETAILED DESCRIPTION OF THE INVENTION

In the following, the advantages and details of the invention are explained in greater detail.

The terms film or plastic film, respectively, and plate or plastic plate, respectively, are used as synonyms throughout the patent application, there being meant films and plates likewise, even if only film or plate are being mentioned.

### Plastic Film or Plate:

The thermoplastic plastic plate or film constitutes the carrier for the lacquer cover layer and may be thermally deformed. The thermoplastic plastic film may be configured as a mono- or multi-layer. In the case of a multi-layered thermoplastic plastic plate or film, this is preferably a co-extrudate. The plastic plate or film is preferably a multi-layered composite, which comprises a substrate layer and at least one further layer.

As a major constituent for the thermoplastic plastic plate or film there are used thermoplastic materials such as thermoplastic polymers. Within the scope of the invention a thermoplastic material is understood as a plastic material, which may be thermoplastically deformed within a certain temperature range. The thermoplastic deformability is a reversible process, such that the thermoplastic material may be repeated into the deformed condition by means of cooling and heating as often as desired. As thermoplastic materials there are summarized pure plastic materials (homopolymers, hetero- or copolymers, respectively) and plastic blends (mixtures of various plastic materials).

As thermoplastic materials there may be mentioned polyolefins, styrene polymers, polycarbonate (PC), poly-acrylates, polyesters, and so on. For the group of the polyolefins, there may be mentioned, e.g., polyethylene or polypropylene. For the group of styrene polymers there may be mentioned, for example, acrylonitrile-butadiene-styrene terpolymers (ABS), polystyrene (PS), impact-modified polystyrene (HI-PS), acrylonitrile-styrene acrylic esters (ASA), other styrene units comprising copolymers. For the polyesters, there are to be mentioned polyethylene terephthalate (PET) or modified copolymers such as glycol-modified polyethylene terephthalate (PETG). Polymethyl methacrylate (PMMA) and impact-modified polymethyl methacrylate (HI-PMMA) are one of the most important representatives of the polyacrylates. The thermoplastic materials may, for example, further be thermoplastic materials, e.g., thermoplastic elastomers (TPE), olefin-based thermoplastic elastomers (TOP) or thermoplastic polyurethane (TPU).

There may be further present a blend of plastic materials as a thermoplastic material, or it may be necessary to add additional substances in order to obtain the desired characteristics. As blend of the plastic materials mentioned above, there may be mentioned, e.g., ABS/PMMA or ABS/PC.

If the thermoplastic plastic plate or film is configured as a multi-layer, then the individual layers may also contain the polymers mentioned above. Combinations of PMMA and ABS or PC and PMMA, such as, e.g., plastic films with ABS or PC as a major component for the carrier layer and PMMA as a further layer of the plastic film, are also worth mentioning. The lacquer layer is then applied on top of the upper layer of the plastic film (e.g., PMMA).

Optionally, the layers may also contain mill material, recyclate or regenerate (e.g., resulting from preceding production steps or the adjustment of the extrusion plant or the fringe cutting). There may also be added colourants and/or UV-additives.

There may also be added matting agents, which are in general understood as additives, which influence the surface of a coating in such a way such that its gloss grade is being reduced. This is usually associated with an increase of the surface roughness, which shows an improved processing behaviour in the subsequent process, the lamination process. Suitable matting agents have been known to those skilled in the art and include, e.g., inorganic fillers, in particular silica, or cross-linked polymers in bead-shape (“polymer beads”), preferably acrylate beads. The amount added is preferably from 0.1% w/w to 5% w/w.

Pigments, dyes or effect pigments are designated as colourants. In contrast to dyes, pigments cannot be dissolved in the carrier medium. As a carrier medium there is designated the substrate, into which the pigment is incorporated, for example, a lacquer or a plastic material. Dyes and pigments both are colourants and may be inorganic or organic, coloured or achromatic.

The ultraviolet proportion of sun light may lead to photo-degradation. In order prevent effects of this type, there may be added UV additives. Depending on the action mode of these UV additives, there is distinguished between UV absorption agents and UV stabilizing agents. UV absorption agents lead to the absorption of UV radiation, which passes the polymer, converting it into thermal energy. UV stabilizing agents inhibit the free radicals, which are developed by way of UV radiation, stopping the further disintegration thereof.

The thickness of the substrate layer is preferably from 50 μm to 5 mm. Any additional layers preferably have a thickness from 5 μm to 1 mm.

### Lacquer Cover Layer:

The lacquer for the lacquer cover layer is originally a multi-component lacquer (at least a two-component lacquer) or a lacquer containing at least two components, which cure differently. More particularly, the multi-component lacquers are a mixture of monomers and oligomers, which polymerize (=cure) in a different way.

In the present case, there are provided two constituents, which cure independently from one another. The first constituent is already cured in the finished product (the thermally deformable plate or film). For example, the first constituent may also be a thermally curable component. In this case, the second constituent has to be curable at a higher temperature than the first constituent.

The first constituent in the lacquer is preferably a component curable by means of UV light, i.e. in the finished product a constituent that has been cured by means of UV light.

Possible components that may be cured by means of UV light may, for example, contain acrylate oligomers such as urethane (meth) acrylate oligomers, e.g., Laromer® UA 9072 by BASF. Further ingredients are reactive diluents, photoinitiators, optionally defoaming agents and UV additives.

There is preferably provided that the UV-light-curable component comprises acrylate oligomers, preferably, urethane (meth) acrylate oligomers, reactive diluents and photoinitiators. Photoinitiators are chemical compounds, which upon irradiation with UV light will be subjected to photolysis and may form reactive species such as radicals and may cause polymerization. Reactive diluents are substances, which decrease the viscosity of the lacquer and become part of the lacquer by way of copolymerization in the subsequent curing of the lacquer. There may be used, for example, epoxides, styrene or acrylates.

Within the scope of the invention UV light is understood as radiation having a wavelength in the range of about 380 nm to 10 nm.

In contrast to common dual-component lacquer systems, the formulation does not have any pot life.

The thermally curable component comprises preferably blocked isocyanates and polyols. A blocked isocyanate is an addition compound of a highly reactive isocyanate, e.g., with alcohols (“urethanes”) or amines (“ureas”). At higher temperatures, these isocyanates are then again released in order to then participate in the polymerization reaction with the polyols as reaction partners. As polyols there may be mentioned, for example, aromatic polyesters such as, e.g., Terol 250 ® Polyol by Huntsman.

The lacquer cover layer is produced by applying the lacquer onto the substrate, followed by partial curing. The partial curing only relates to the first component but not to the second component. By using UV additives (UV absorbing agents and UV stabilizing agents) to the extent of 0.01 to 5% w/w, the materials and colourants used in the layers lying underneath are protected against UV radiation, whereby colour stability a well constant material features are significantly improved over the duration of use at irradiation with UV light. The cover layer or the UV lacquer, respectively, may be transparent, or various colourants may be used. In the lacquer layer there may also be contained nanoparticles for increasing various characteristics.

There have been known numerous methods for the application of coatings. There may mentioned painting, rolling, spraying, flooding, pouring, blade coating, drum-applying, spatula levelling and by means of rollers. Using these methods, there are applied lacquer systems, which usually contain organic solvents or water or both. The solvents are usually vented off after the coating process in drying chambers, which is why there are existent huge energy and space demands.

The lacquer is preferably essentially free from solvents, as solvents are harmful to the environment. Solvent-containing lacquers do have also other disadvantages arising, for example, from the fact that fluctuations in the thickness may be developed in the lacquer layer due to evaporation.

The lacquer cover layer may be configured glossy as well as matt.

As many plastic materials such as, e.g., PMMA/ABS or PC/PMMA co-extrudates, for example, may be thermoformed at temperatures between 140° C. and 210° C., the blocked isocyanate is preferably such one, which releases isocyanate between 140° C. and 210° C., preferably 160° C. to 190° C., especially preferably between 165° C. and 185° C. ° C. As blocked isocyanates there may, for example, be added aromatic isocyanates (e.g., monomeric diphenyl methane diisocyanates) and/or aliphatic isocyanates (e.g., isophorone diisocyanate). By suitable additives such as blocking agents the temperature may be adjusted at which the second constituent will be cured.

The lacquer has to be thermoformable before the thermal curing of the second constituent. Upon thermal curing (i.e. after curing also of the second constituent), the lacquer may be still thermoplastically deformable, it may, however, also be configured as a duroplastic.

There is further given the possibility to apply a protective film onto the partially cross-linked lacquer layer in order to protect the surface for the transport process as well as for further processing. Protective layers such as these are usually composed of polyethylene or PET, and they may have an adhesive layer on the backside thereof.

The thickness of the cover layer preferably is between 1 μm and 100 μm, preferably about 5 to 20 μm.

The mixing ratio between the first constituent and the second constituent is preferably between 3:1 and 1:2, based on mass proportions.

As thermally curable components are summarized all ingredients, which are required for the thermal curing, while UV light curable components summarize all ingredients, which are cured by means of UV light.

### EXAMPLES AND FURTHER ADVANTAGES OF THE INVENTION

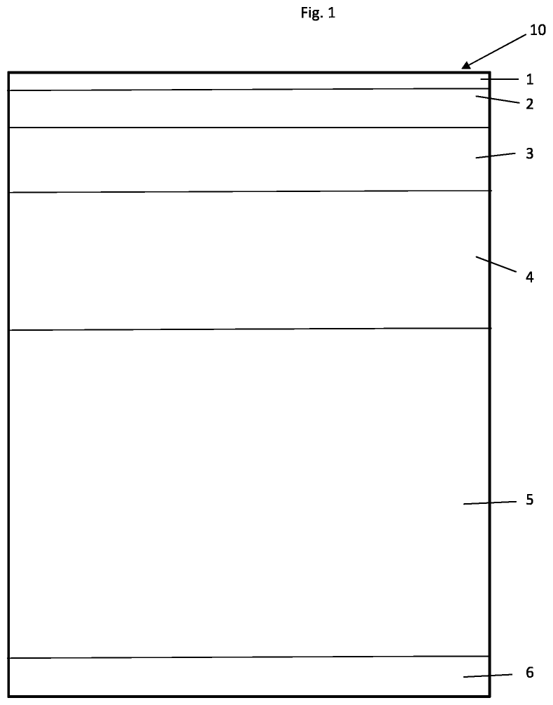

FIG. 1 schematically shows the configuration of a thermally deformable plate according to the example.

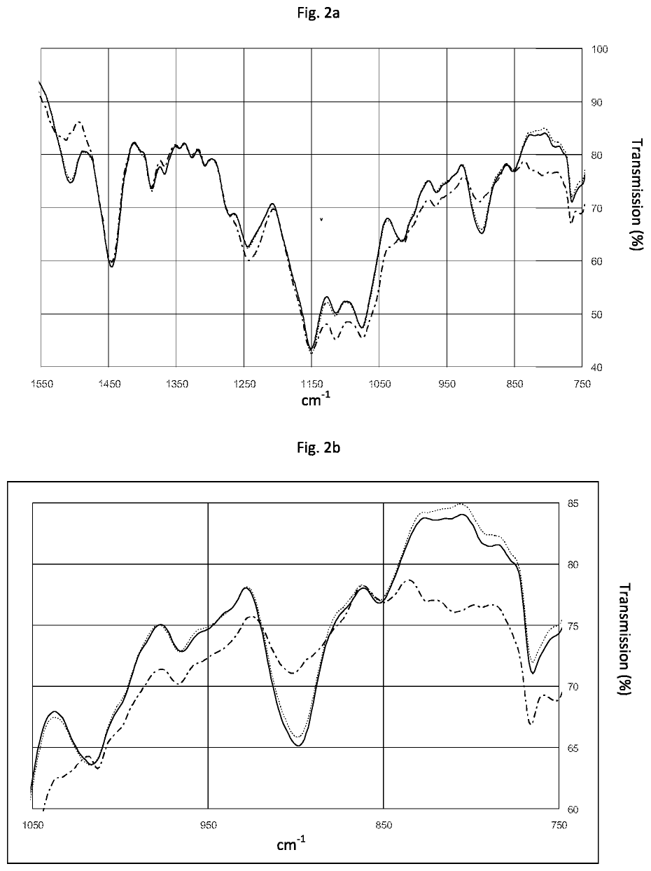

FIG. 2a, 2b show FT-IR spectres, which show the influence of temperature on the curing of the cover layer, wherein FIG. 2b shows a detailed view in the range of 750 to 1050 cm⁻¹.

An advantage of the invention is that either the work step of subsequent lacquer application or of UV curing is omitted. Also the stackability of the plate having the partially cured lacquer layer is advantageous in comparison to prior art. Another advantage lies in the more uniform curing of the three-dimensional element.

The thermally deformable plate may be deformed having a protective film, which is not possible with common dual-cure systems, as these are simply cross-linked in a physical way. In this way, the surface is additionally protected in the processing process as well as in further processing steps or in the transport, respectively. Thermoforming is possible on conventional facilities. The surface of the lacquer cover layer is finger-dry, stackable and storage-stable upon curing of the first constituent (and before curing of the second constituent). The lacquer layer is elastic and stretchable.

In the following table, the obtained characteristics are listed as a function of the thermoforming parameters by way of an example, this being a composite having the following configuration:

Composite having a layered configuration (see FIG. 1):

| | | |
|---|---|---|
| 1 | lacquer cover layer | 10 μm |
| 2 | PMMA | 30 μm |
| 3 | PMMA | 60 μm |
| 4 | PC/ABS blend | 150 μm |
| 5 | PC/ABS blend with regenerate | 1010 μm |
| 6 | PC/ABS blend | 40 μm |

The layers 2 to 6 were co-extruded, and onto layer 2 there was applied a lacquer as a lacquer cover layer (layer 1) by means of a roller. The composition of the lacquer comprises a mixture of the components summarized in table 1:

TABLE 1
Composition of the lacquer of the lacquer cover layer:

| | Component | % w/w | Description |
|---|---|---|---|
| 1 | urethane (meth)acrylate- | 35 | Laromer ® UA 9072 |
| | oligomer | | |
| 2 | 1,6-hexane dioldiacrylate | 10 | Reactive diluent |
| 3 | 2,4,6-trimethylbenzoyl- | 3 | Ciba ® Darocur ®TPO |
| | diphenyl-phosphine oxide | | photoinitiator |
| 4 | isocyanate | 25 | Isophoron-diisocyanate |
| 5 | polyol | 24 | Terol 250 ® |
| 6 | 3,5-dimethyl pyrazol | 2 | blocking agent |
| 7 | Dibutyl-tin-dilaurate (DBTL) | 1 | Meister ZI 4401 catalyst |

The constituents 1 to 3 of the lacquer according to table 1 represent the first constituent having an acrylic component. The constituent 1 to 3 were cured by means of UV light, and the resulting component is thermoplastically deformable upon curing.

The mixture of the components 4 to 7 represents the second constituent of the lacquer cover layer. These components are cured in a second step. In the following table 2 below, the characteristics of the lacquer cover layer after curing the first component (“before deformation”) and after curing the second components by means of thermal treatment by thermoforming were examined. The thermoforming temperature is about 180° C.

TABLE 2
Examination of the lacquer layer after curing the first constituent and
before or after, respectively, curing the second constituent.

| | Acetone test | Finger nail test | |
|---|---|---|---|
| Treatment | acc. to DIN EN | (acc. to BMW | Sun cream test |
| temperature | 12720: 2009 | Group Standard | according to |
| [C. °] | dwell time 5 min) | GS 97034-2)^{a} | GMW14445 |
| Before deformation | 1 | 3 | 4 |
| 160 | 1 | 3 | 4 |
| 170 | 2 | 1 | 1 |
| 180 | 5 | 1 | 1 |
| 190 | 5 | 1 | 1 |
| 200 | 5 | 1 | 1 |

^{a}Test carried out:
Finger nail test according to BMW Group Standard GS 97034-2
Finger nail tester plastic material = PMMA
Diameter = 16 mm; thickness 1 mm
Rounded radius starting from disc edge = 0.5 mm
Hardness = Shore D85
Test speed = 200 (+/−20) mm/s; test force = 20 N

Evaluation of the results according to finger nail test:
grade 1: no trace visible (no change of the surface)
grade 2: mild/small trace visible
grade 3: clear trace visible.

Evaluation of the results according to acetone test:

The test panels were evaluated by comparison with the reference surface for each liquid according to the qualification code described in the following, qualification code according to DIN EN 12720:2009-07:
5=No visible changes (no damage)
4=Slight change of gloss or colour (reflection) or detectable limited marking
3=Mild marking to be observed at various angles, e.g., nearly complete circle or circular area
2=Strong marking (edges), with the surface structure, however, being more or less unchanged
1=Strong marking, the surface structure is changed, and the surface material is completely or partially destroyed, or the paper adheres to the surface

Evaluation of the sun cream test according to GMW 14445:
1=No change
2=Slight change of gloss or colour, little swelling or any other acceptable effects/changes
3=Significant change of gloss or colour, heavy swelling, blister, peel-off or any other not-acceptable effects/changes
4=Very significant change of gloss or colour, very heavy swelling, blister, peel-off or any other not-acceptable effects/changes

FIG. 1 schematically shows the thermally deformable plate of the example in a cross-sectional view, comprising a cover layer 1 and a thermoplastic plastic plate comprising in total five layers 2, 3, 4, 5, 6. The substrate layer 5 therein is the major part. The remaining layers 2, 3, 4, 6 may provide additional mechanical and/or optical characteristics. On the surface of the lacquer cover layer 1 in the example shown, there is indicated a protective layer 10. The plastic film or plate need not contain 5 layers, it may, however, also contain only one or two or several layers.

FIG. 2 shows FT-IR spectres of the lacquer cover layer 1 according to the invention. The continuous line shows the lacquer cover layer after the application of lacquer and curing of the first constituent (the acrylic components 1 to 3 in the example shown) onto the plastic plate. Then this plate was pre-dried at 70° C. for 24 hours in order to remove any residual moisture of the plastic plate. The FT-IR spectrum of the lacquer cover layer is indicated using dots. The difference to the measurement before storage at 70° C./24 hours is little.

Upon thermoforming of the plate (dot dashed line), the FT-IR spectre will change significantly; in particular the transmission at the characteristic band at about 900 cm becomes markedly increased. The physico-chemical features of the surface of the lacquer cover layer upon curing of the second constituent were improved significantly. Surprisingly, a thermal curing as a final curing step of a lacquer cover layer for plastic material provided the same surface quality (in physical and chemical regard) as UV curing as a final step. In the thermal curing of lacquers onto plastic materials it has never been possible to obtain such results.

1. A thermally deformable plate or film, comprising a thermoplastic plastic plate or plastic film and, arranged thereupon, a lacquer cover layer having at least two constituents, wherein the lacquer cover layer has a thermally deformable component as a first constituent and a thermally curable component as a second constituent, wherein the cured, thermoformable component is a component that is cured by means of UV light.

2. A thermally deformable plate or film according to claim 1, wherein the thermally curable component is selected such that it is cured at a temperature, at which the thermoplastic plastic plate or plastic film is thermoformable.

3. (canceled)

4. A thermally deformable plate or film according to claim 1, wherein the component that is cured by means of UV light is a polymer, including acrylate oligomers, reactive diluents, and photo initiators.

5. A thermally deformable plate or film according to claim 1, wherein the thermally curable component comprises blocked isocyanates and polyols.

6. A thermally deformable plate or film according to claim 1, wherein there is arranged a protective layer on top of the cover layer.

7. A deformed plate or film, comprising a plate according to claim 1, wherein the thermally curable component has been cured.

8. An element, comprising a thermoplastically deformed plate according to claim 7.

9. An element according to claim 8, wherein the element is a car body element, a sanitary element, a furniture film or a housing.

10. A method for the production of a thermally deformable plastic plate or plastic film according to claim 1, comprising the following steps:
(i) providing a thermoplastic plastic sheet or plastic film,
(ii) applying a lacquer having a first constituent curable via UV light, which is thermoplastically deformable in the cured condition, and a second, thermally curable constituent,
(iii) curing of only the first curable component.

11. (canceled)

12. A method for the production of a deformed plastic plate or plastic film according to claim 7, comprising either the following steps:
(i) providing a thermoplastic plastic sheet or plastic film (2. 3);
(ii) applying a lacquer having a first constituent curable via UV light, which is thermoplastically deformable in the cured condition, and a second, thermally curable constituent;
(iii) curing of only the first curable component;
(iv) thermoforming the plastic plate into a desired three-dimensional shape while simultaneously curing the thermally curable component;
or comprising the following steps:
(a) providing a thermoplastically deformable plate or film according to claim 1, and
(b) thermoforming the plastic plate into a desired three-dimensional shape while simultaneously curing the thermally curable component.
